(19) United States
(12) Patent Application Publication
(10) Pub. No.: US 2014/0147619 A1
(43) Pub. Date: May 29, 2014

(54) COMPOSITE ARTICLE AND A METHOD OF FORMING A COMPOSITE ARTICLE

(71) Applicants: Tommy Grankaell, Borensberg (SE); Per Hallander, Linkoeping (SE); Anders Lundberg, Vikingstad (SE); Tonny Nyman, Linkoeping (SE); Bjoern Weidmann, Borensberg (SE); Mikael Petersson, Linkoeping (SE)

(72) Inventors: Tommy Grankaell, Borensberg (SE); Per Hallander, Linkoeping (SE); Anders Lundberg, Vikingstad (SE); Tonny Nyman, Linkoeping (SE); Bjoern Weidmann, Borensberg (SE); Mikael Petersson, Linkoeping (SE)

(73) Assignee: SAAB AB, Linkoeping (SE)

(21) Appl. No.: 13/978,681

(22) PCT Filed: Jan. 21, 2011
(86) PCT No.: PCT/SE2011/050063

§ 371 Date: Aug. 15, 2013

(51) Int. Cl. B32B 5/26; B29C 70/30

(52) U.S. Cl. CPC B32B 5/26; B29C 70/30
USPC 428/113; 264/258

(57) ABSTRACT

The present invention relates to a composite article 801, wherein the article has a longitudinal direction L and a transversal direction T, the article 80 comprises a stack of plies wherein one ply is a bottom ply and one ply is a top ply, most of or all of the plies comprise fibres, and the article comprises a plurality of plies having fibres substantially in the orthogonal direction 810 to the longitudinal direction L of the article 801 and the stack further comprises a plurality of plies having fibres substantially in the same direction 811 as the longitudinally direction L of the article 801 and/or a plurality of plies having fibres in the diagonal direction (812, 813, 815, 816, 817, 818) of the longitudinal direction (L) of the article (801), wherein at least one of the ply/plies having fibres substantially in the orthogonal direction 810 to the longitudinal direction L of the article 801 comprise fibres that are stiffer than the fibres in the other plies which have less stiff fibres. The present invention also relates to a method of forming an article on a tool, the tool having one longitudinal direction L and one transversal direction T.

### TECHNICAL FIELD

The present invention relates to a composite article and a method of forming an article on a tool.

The article is made of resin prepregs or plies, such as thermo setting plastic comprising fibres.

### BACKGROUND ART

Composite articles may be produced by mechanical forming, method hot drape forming (HDF) or vacuum forming. When producing composite articles by hot drape forming, it requires the use of pressure onto stacks of prepregs or plies against a tool. A vacuum bag is used to achieve a pressure such that wrinkles and trapped air in the stack can be forced out under vacuum pressure. The vacuum bag can be used for curing the resin of the plies in an autoclave or in an oven at elevated temperature and pressure. After curing the bag is removed from the forming tool and the article is removed from the tool. By mechanical forming a roll could be used to conform a stack of prepregs or plies against a tool.

When articles are hot drape formed or mechanical formed on a tool, which has one substantially longitudinal direction and one substantially transversal direction, wrinkles are easily formed if the tool has some small curvature, bevels, any protrusion or any depression formed in the tool. It is thus desirable that formation of wrinkles at the location of bevels or other projections or depressions of the article is eliminated in the stack during the forming process.

US 2004/0115299 discloses a method where the vacuum bag is made thinner within the area of a forming surface, which more readily stretches and conforms the stack to the forming surface.

The applicant has found a method in which it is possible to hot drape form an article on a tool without creating wrinkles in the article. This is disclosed in WO 2010/056164 which relates to a method in which a certain stacking sequence is used for avoiding wrinkling when forming an article by hot drape forming. Plies having fibres in the longitudinal direction of the tool, plies having fibres in the orthogonal direction of the tool and fibres having a diagonal direction of the tool are arranged in a specific order in the stack in order to avoid wrinkles. In some cases, there might still be some problems during the forming in which wrinkles are formed in the article. The inventors of the present invention have now evaluated the stacking method.

The present invention intends to solve the problems above.

### SUMMARY OF THE INVENTION

The present invention relates to a composite article, wherein the article has a longitudinal direction and a transversal direction, the article comprises a stack of plies wherein one ply is a bottom ply and one ply is a top ply, most of or all of the plies comprise fibres, and the article comprises a plurality of plies having fibres substantially in the orthogonal direction to the longitudinal direction of the article and a plurality of plies having fibres substantially in the same direction as the longitudinally direction of the article, wherein at least one of the ply/plies having fibres substantially in the orthogonal direction to the longitudinal direction of the article comprise fibres that are stiffer than the fibres in the other plies which have less stiff fibres.

Further, the present invention relates to a method of forming an article on a tool, the tool having one longitudinal direction and one transversal direction, wherein the method comprises the steps of:
arranging a stack of plies, wherein one ply is a bottom ply and one ply is a top ply, and wherein most of or all of the plies comprise fibres, wherein the stack comprises a plurality of plies having fibres substantially in the orthogonal direction to the longitudinally direction of the tool and a plurality of plies having fibres substantially in the same direction as the longitudinally direction of the tool, so that when positioned on the tool at least one of the ply/plies having fibres substantially in the orthogonal direction to the longitudinal direction of the tool have fibres that are stiffer than the fibres in the other plies which have less stiff fibres;
   conforming the stack to the tool with a forming medium; and
   removing the article from the tool.

### BRIEF DESCRIPTION OF THE DRAWINGS

The present invention will now be described by way of example with reference to the accompanying schematic drawings, of which:

FIG. 1 shows a tool according to the present invention, in a view from above, in which different fibre directions of plies are disclosed.

FIG. 2 shows a cross-section in the longitudinal direction of a tool with a stack of plies according to the present invention.

FIG. 3 shows a side view of a part of a tool according to the present invention.

FIG. 4 shows a cross-section of a part of the tool shown in FIG. 3 and a stack of plies on the tool part.

FIG. 5 shows a cross-section in the transversal direction of a part of a composite article produced according to a prior art method.

FIG. 6 shows a cross-section in the transversal direction of a tool according to the present invention, a stack of plies on the tool and a forming medium in an apparatus for forming the stack.

FIG. 7 shows a cross-section in the transversal direction of a tool according to the present invention, a stack of plies on the tool and a forming medium.

FIG. 8 shows an article according to the present invention.

FIG. 9 shows an article according to the present invention.

### DEFINITIONS

When referring to the direction of fibres in the plies, it is referred to the direction of the fibres in an angle to the longitudinal direction of the article or of the tool if nothing else is stated. The stack is transferred to the tool in such a way that the fibres are arranged in different ways on the tool as defined in the claims.

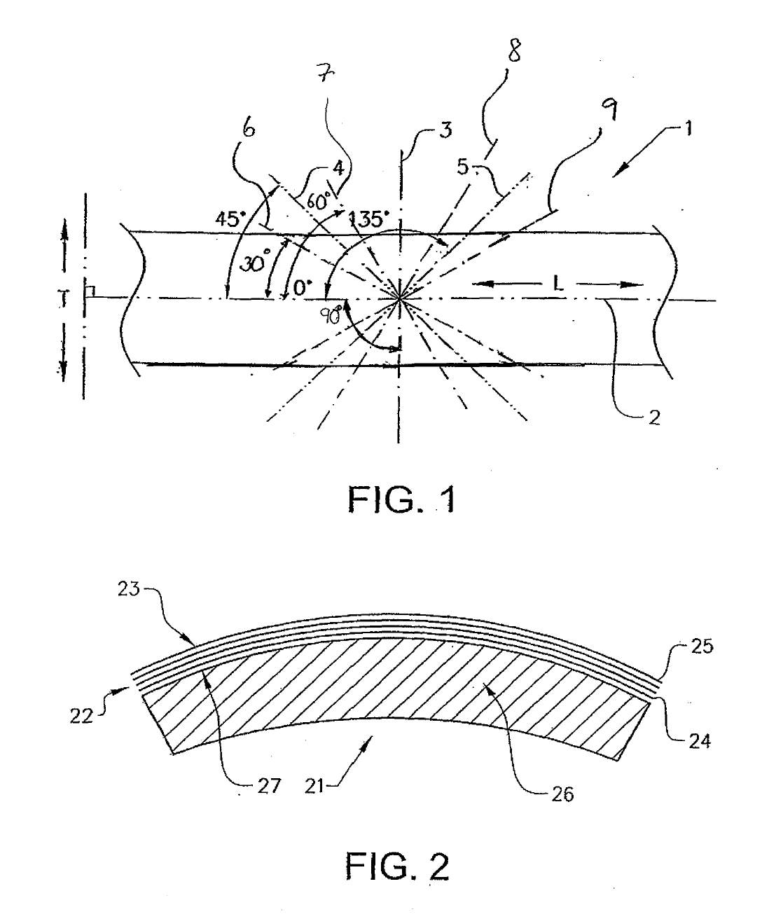

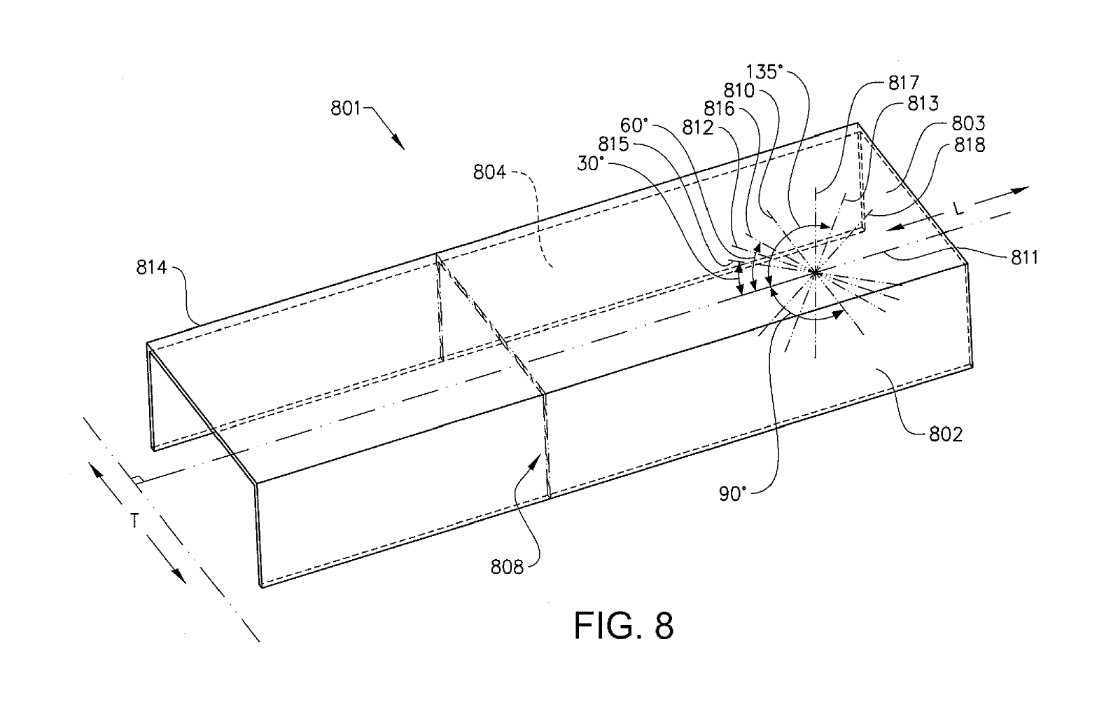

In FIG. 1, a tool 1 is shown in a view from above. The tool has a longitudinal direction L and a transversal direction T. Different directions of fibres are also shown in the Figure. A ply having the fibres in the same direction 2 as the longitudinal direction L of the tool 1 is also defined to have the fibres in an angle of 0° to the longitudinal direction L of the tool 1. A ply having the fibres orthogonal 3 to the direction of the tool is also defined to have the fibres in an angle of 90° to the longitudinal direction L of the tool 1. Further, the fibre direction diagonal to the longitudinal direction L are such fibres that have the angle of 30° 6 to 60° 7 and 120° 8 to 150° 9 to the longitudinal direction L of the tool 1, or to the article, shown in FIG. 8. Diagonal fibres may thus have the angle 45° or 135°, shown as 4 and 5 in the FIG. 1, to the longitudinal direction L. However, the diagonal direction is extending from the angle 30° to 60° and from 120° to 150°, which is shown as 6, 7, 8 and 9 in FIGS. 1 and 815, 816, 817 and 818 in FIG. 8. The same applies when referring to an article.

By intra ply sliding is meant sliding of the fibres in one ply, while inter ply sliding is sliding between the plies.

### DETAILED DESCRIPTION

The present invention relates to a composite article 801 shown in FIG. 8, wherein the article has a longitudinal direction L and a transversal direction T, the article 801 comprises a stack of plies wherein one ply is a bottom ply and one ply is a top ply, most of or all of the plies comprise fibres, and the stack comprises a plurality of plies having fibres substantially in the orthogonal direction 810 to the longitudinal direction of the article 801 and the stack further comprises a plurality of plies having fibres substantially in the same direction 811 as the longitudinally direction L of the article 801 and/or a plurality of plies having fibres substantially in the diagonal direction 812, 813, 815, 816, 817, 818 of the longitudinal direction L of the article 801, wherein at least one of the ply/plies having fibres substantially in the orthogonal direction 810 to the longitudinal direction L of the article 801 comprises fibres that are stiffer than the fibres in the other plies which have less stiff fibres. Such an article has the advantage that wrinkles are avoided in the article.

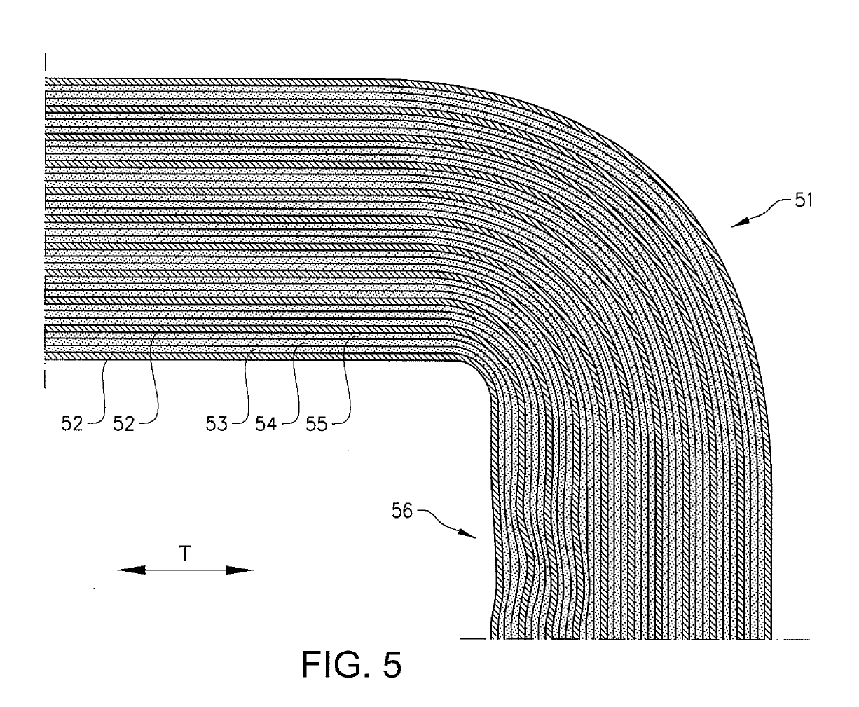

Fibres in the orthogonal direction may be compressed in the longitudinal direction of the fibre. Observe that the longitudinal direction of the fibre is not related to the direction of the article or the tool. One reason for compression in the plies having fibres substantially in the orthogonal direction to the longitudinal direction of the article may be an inter ply sliding in those plies during forming of the article and during this inter ply sliding the orthogonal ply may be locked. When the fibres are sliding in the orthogonal direction during forming and the ply is locked, the fibres may be compressed in the fibre length and the fibres may then buckle. The plies may be locked by each other during the forming and thus buckling may appear. Such buckling is illustrated in FIG. 5, which shows a cross section in the transversal direction of a corner 51 of a composite article produced according to a prior art method. The transversal direction T, which is orthogonal to the longitudinal direction of the article, is shown in the Figure. The plies 52 having fibres substantially in the orthogonal direction of the article are disclosed by a lighter colour. Between the orthogonal plies 52 are other plies 53, 54, 55 arranged. Those plies 53, 54, 55 have fibres in the longitudinal direction and/or fibres in the diagonal direction. It can be seen that the plies 52 have been compressed in the longitudinal direction of the fibres and thereby buckled 54 below the corner of the article. Buckling of the orthogonal plies 52 will affect the surrounding plies 53, 54, 55 to be buckled in the same way. Thus, all plies will be buckled due to the buckling of the orthogonal plies 52. The buckling is a larger problem close to the tool than further away from the tool. If the fibre is stiffer, the compression is avoided and the fibre will conform to the form of the tool. When producing the article, the stiffer fibres in the plies having fibres substantially in the orthogonal direction 810 avoid compression of the ply/plies. This avoids that the fibres are bended in the wrong direction and thus avoids wrinkling. The plies having stiffer fibres will cooperate with the plies having less stiff fibres in an advantageous way and the plies having stiffer fibres will conform easier to the tool as disclosed above.

It is defined that most of or all of the plies comprise fibres. For example a ply comprising resin or polymer material but no fibres could be arranged between plies comprising fibres. However, this will only concern a few plies, if any. The fibre reinforced polymer plies have unidirectional fibres in the plies.

Further, the present invention relates to a composite article, wherein at least one of the ply/plies having fibres substantially in the orthogonal direction 810 to the longitudinal direction L of the article 801 has a cured ply thickness which is smaller than the cured ply thickness of the other ply/plies. It is a common way to use the cured ply thickness as a dimension for the thickness of plies. Smaller cured ply thickness of the plies further avoid compression of the ply/plies and the ply/plies will conform to the tool during forming. This in turn avoids bending of the plies and fibres in an incorrect way, and wrinkles are avoided in the composite article. Plies having smaller cured ply thickness do not need to be sheared as long distance as a ply having a thicker cured ply thickness. Plies having a thinner cured ply thickness thus have a shorter distance to be sheared during formation. This leads to that the ply having a smaller cured ply thickness will be less prone to compression in the longitudinal direction of the fibres in the ply/plies.

The ply/plies having fibres substantially in an orthogonal direction and a smaller cured ply thickness may also comprise fibres which are stiffer than the other plies which have less stiff fibres. However, one ply having fibres substantially in an orthogonal direction may comprise stiffer fibres than the other plies, while another ply having fibres substantially in an orthogonal direction may have a smaller cured ply thickness than other plies.

The ply/plies having a smaller cured ply thickness may have a cured ply thickness of <0.15 and the cured ply thickness of the other ply/plies may >0.15. However, in order to obtain a higher effect of the thickness difference, the ply/plies having a smaller cured ply thickness could have a cured ply thickness of ≦0.14 mm and the cured ply thickness of the other ply/plies could ≧0.17 mm. With the difference of the cure thickness wrinkling is avoided since the compression is avoided of the ply/plies having a lower cured ply thickness. Further, deformation is avoided in the ply/plies having a higher cured ply thickness. The combination of plies having different cured ply thickness and having fibres in different directions will also improve the mechanical properties of the composite article.

As disclosed above, at least one of the ply/plies having fibres substantially in the orthogonal direction T to the longitudinal direction L of the article comprises fibres that are stiffer than the fibres in the other ply/plies. The stiffer fibres may have a Young Modulus of at least 250 GPa and the less stiff fibres have a Young Modulus of less than 250 GPa. However, in order to have a quite good effect of the stiffer fibres compared to the less stiff fibres, the stiffer fibres may have a Young Modulus of at least 20 GPa more than the less stiff fibres. Further improved avoidance of compression could be obtained if the Young Modulus of the stiffer fibres are at least 30-50 GPa more than the less stiff fibres. Stiffer fibres may have a Young Modulus of about 280-300 GPa and less stiff fibres may have a Young Modulus of about 230-245 GPa.

According to the present invention, the bottom ply may have fibres in the orthogonal direction and the bottom ply can comprise fibres that are stiffer than the fibres in the other plies which have less stiff fibres. Further, a ply close to the bottom ply having fibres substantially in the orthogonal direction may comprise fibres that are stiffer than the fibres in the other plies which have less stiff fibres. The bottom ply is the ply which is applied to the tool during forming of the article. The buckling may be most severe close to the tool and therefore it may be advantageous to have a ply having fibres substantially in the orthogonal direction close to the bottom ply of the article which comprise fibres that are stiffer than the fibres in the other plies which have less stiff fibres. The ply or plies close to the bottom ply may comprise fibres in the orthogonal direction and that are stiffer than the fibres in the other plies which have less stiff fibres.

Further, the bottom ply may have fibres in the orthogonal direction and the bottom ply can have a cured ply thickness which is smaller than the cured ply thickness of the other ply/plies. Further, a ply close to the bottom ply having fibres substantially in the orthogonal direction may have a cured ply thickness which is smaller than the cured ply thickness of the other ply/plies. The ply or plies close to the bottom ply may comprise fibres in the orthogonal direction and have a cured ply thickness which is smaller than the cured ply thickness of the other ply/plies.

According to the present invention, all the plies having fibres substantially in the orthogonal direction 810 may comprise fibres that are stiffer than the fibres in the other plies. The plies in the other directions, such as in the longitudinal direction of the article would then have fibres with less stiff fibres. Such articles will have improved properties as avoidance of wrinkles and improved mechanical properties are then obtained. The stiffer fibres are more expensive than the less stiff fibres. An improved article is obtained due to the stiffer fibres and still all plies do not need fibres which are as stiff as the plies having the stiffer fibres.

Further, all the plies having fibres substantially in the orthogonal direction 810 may have a cured ply thickness which is smaller than the cured ply thickness of the other ply/plies. This will further avoid wrinkle formation in the composite articles and the mechanical properties are improved. At the same time as wrinkle is avoided in the plies comprising stiffer fibres and plies having a smaller cured ply thickness, the plies comprising less stiff fibres and a thicker cured ply thickness will be less deformed.

In the composite article according to the present invention, the bottom ply and the top ply may have fibres in a substantially orthogonal direction 810 to the longitudinal L direction of the article 801 and at least one ply has the fibres substantially in the same direction 811 as the longitudinal direction L of the article 801 arranged between plies having fibres substantially orthogonal 810 to the longitudinal direction L of the article 801, and at least one ply has fibres substantially diagonal 812, 813, 815, 816, 817, 818 to the longitudinal direction L of the article 801, wherein such ply or plies are arranged next to each other or between plies having fibres substantially orthogonal 810 to the longitudinal direction L of the article 801. The sliding of the diagonal plies will be improved by being arranged between orthogonal plies or diagonal plies. The good sliding of the orthogonal plies will reduce the risk of wrinkling of the article during manufacturing.

It is pointed out that the composite article may comprise at least one ply/plies having fibres in the angle of 30° 815 to 60° 816 and 120° 817 to 150° 818 to the longitudinal direction L of the article. Those plies are defined to be diagonal to the longitudinal direction L of the article. Such plies are arranged next to each other or between plies having the fibres substantially in the orthogonal direction.

The article may comprises a stack, wherein the bottom ply has the fibres substantially orthogonal 810 to the longitudinal direction L of the article 801, the next four plies have the fibres substantially diagonal 812, 813, 815, 816, 817, 818 to the longitudinal direction L of the article 801, the next ply has the fibres substantially orthogonal 810 to the longitudinal direction L of the article 801, the next four plies have the fibres in substantially the same direction as the longitudinal direction L of the article 801, the next ply has the fibres substantially orthogonal 810 to the longitudinal direction L of the article 801, the four next plies have the fibres substantially diagonal 812, 813, 815, 816, 817, 818 to the longitudinal direction L of the article 801, the next ply has the fibres substantially orthogonal 810 to the longitudinal direction L of the article 801. Such a stacking sequence is good for composite articles, which will have no wrinkles. At least one of the ply/plies having fibres substantially in the orthogonal direction 810 to the longitudinal direction L of the article 801 will have fibres that are stiffer than the other ply/plies as disclosed above. Further, the ply/plies having fibres substantially in the orthogonal direction 810 to the longitudinal direction L of the article 801 may have a cured ply thickness which is smaller than the cured ply thickness in the other ply/plies.

In order to get a simple quasi isotropic lay-up, the directions 0°, 90°, 45° and 135° are all used. The plies having fibres in different directions could be used in the same number, i.e. for example four 0° plies, four 90° plies, four 45°plies and four 135° plies. However, different lay-ups can also be used, and it depends on how the article will be used and the properties which are needed in the article. The 0° plies give the article rigidity and those plies can be arranged in about the middle of the stack. The 45° and 135° could be exchanged with other diagonal angles according to the definition. The angles could for example be 30° and 150° or 60° and 120°.

The article 801 may also comprise at least one curved part 814. At curved parts, such as corners, buckling is common to occur. The ply/plies having the fibres in the orthogonal direction to the longitudinal direction of the article may bend in the wrong way and may be wrinkled quite easily during the forming of the article. When the fibres in the ply/plies having fibres substantially in the orthogonal direction to the longitudinal direction of the article are stiffer, the buckling is avoided. The stiffer fibres are less prone to compression and thereby buckling is avoided. This is especially useful at curved parts of composite articles. A curved part 814 is disclosed in the composite article 801 and may be for example a corner.

In FIG. 8 is further a cross section disclosed. An upper part 803 and two flanges 802, 804 of the article are disclosed. The article could for example be a beam.

A corner is here an example of a curved part. However, any other curve form could be used. An example of a curved form is a radius. A further example is as shown above, a corner. If the corner is rounded it also may comprise a radius. Further, several curved parts could be used, or a double curved part. Even if a corner is shown in FIG. 8, several more rounded forms are included in the present invention. The ply or plies are formed down from one surface to another surface in the area around the curved part.

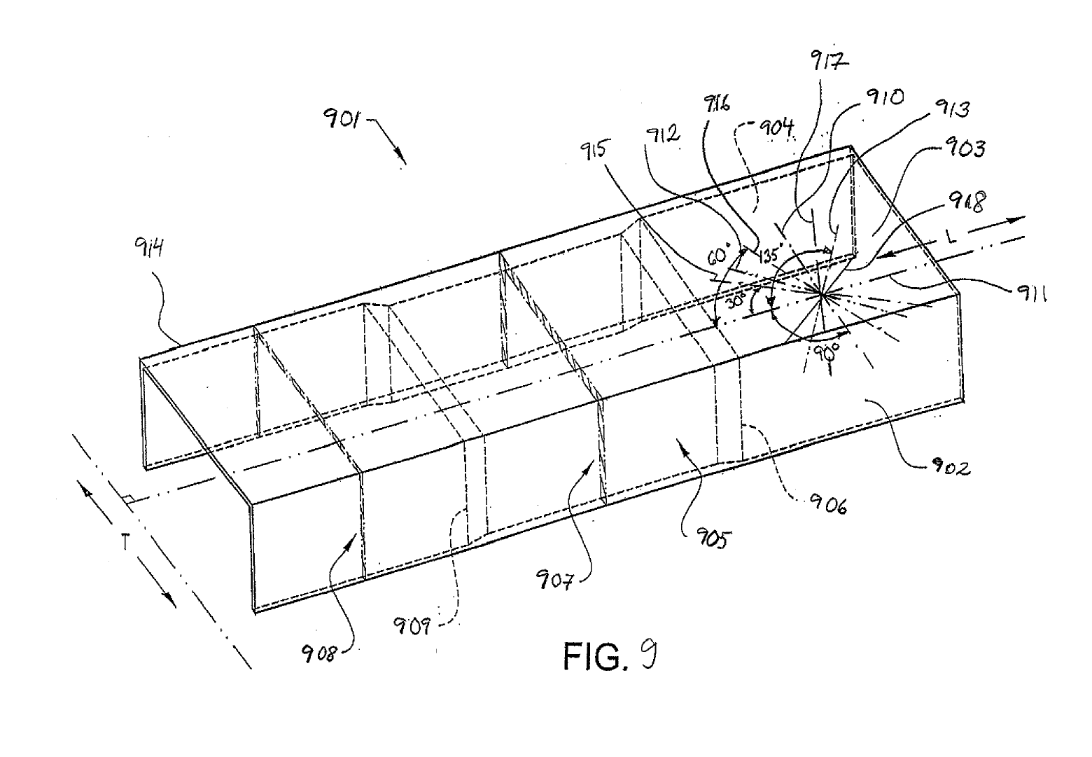

The present invention also relates to a composite article, wherein the article includes a thicker region or a build-up area 905. Such an article 901 is disclosed in FIG. 9. The article comprises at least one ply which covers only the area of the thicker region or the build-up area 905. Sometimes this area is also called a pad-up area. The term pad-up area is however also used for the area of a tool, on which the thicker region or build-up area is made on. This is referred to further below. The terms “thicker region” or “build-up area” 905 are used for a thicker area of the article, which can be seen in FIG. 9. The same reference numbers as in FIG. 8 are used, except that the first figure “8” is exchanged with “9” in FIG. 9. Further, two cross sections 908 and 907 are disclosed in FIG. 9, wherein the cross section 907 of the pad-up area 905 is larger due to the thickening of the article 901 in this part. Transition areas 906, 909 are disclosed showing the transition between the thickened region 905 and the other parts at the ends of the article. Further down, it is described how such an area is built up by the method. A thicker area or a build-up area 905 is used in order to strengthen the article in the area. It could for example be used for the positioning of fastening elements, which might require a stronger part of an article.

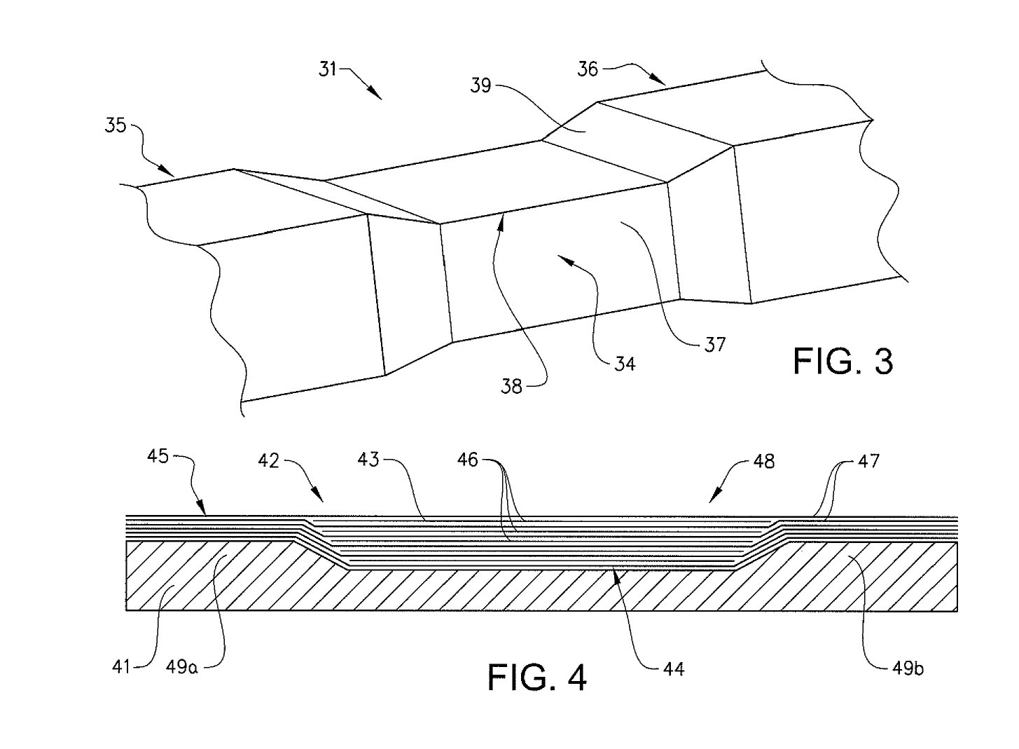

In the field of composite articles, a thicker region 905 of the article has the purpose to form a strengthened region of the article. A thicker region 48 is also disclosed in FIG. 4. In such a region, fastening elements could be arranged for example. This makes it possible to have a light article, but still makes it possible to arrange fastening elements in the article. This is a desire in for example the air craft industry. FIG. 4 discloses several plies being applied in a stack 42 on a tool 41. Plies 43, 46 cover only a depressed part and plies 45, 47 cover both the depressed part and the protruding part 49a, 49b of the tool 41 are arranged on the tool 41. This leads to an article that will have a thicker region 48 in the article. The plies 46 may in this context be expressed as interleaved plies. FIG. 3 further discloses a tool 31, which have a depressed part 34 and protruding parts 35, 36. A transition area 39 is arranged between the depressed part 34 and the protruding part 36. A curved part 38 is also disclosed. A side part 37 of the depressed part is also disclosed.

Further, the composite article may comprise at least one ply having fibres in substantially diagonal to the longitudinal direction L of the tool that comprise/s particles selected from the group of thermoplastic tougheners, nano particles, micro particles, elastic particles, elastomer particles and polymer particles or a combination of them. Such an article has the advantages that no wrinkles are formed in the article and the thickness of thinning of the article is avoided. The particles increase the friction between the fibres in the ply in which the particles are comprised, preventing the fibres from sliding away from each other during the production method. Thus, the thinning of the ply is prevented during production of the article when the ply comprises particles and fewer articles with defects are made. All the plies having fibres substantially in the longitudinal direction may comprise particles. It may be especially advantageous to include particles in special areas, such as in curved parts of the tool or curved parts of the article. The friction of the fibres is increased by the addition of the particles. The particles are disclosed and described in PCT/SE2010/050518 and those particles disclosed in PCT/SE2010/050518 can be used according to the present invention.

The particles have improved the possibility of the plies having fibres substantially in the diagonal direction to the longitudinal direction L to keep the fibres in place, in order to prevent thinning of the article. When the article contains plies having fibres substantially diagonal 812, 813, 815, 816, 817, 818 to the longitudinal direction L of the article, its mechanical properties are improved. Further, the thinning of the article is avoided, which also improves the mechanical strength of the article, and the particles may also give additional strength to the article. Besides, the article is not wrinkled. Further, all plies having fibres in the diagonal direction may comprise particles.

A tool for forming an article according to the present invention is disclosed in for example FIGS. 1 and 2. The present invention relates to a method of forming an article on a tool, the tool having one longitudinal direction L and one transversal direction T, wherein the method comprises the steps of:
arranging a stack 22 of plies 23 wherein one ply is a bottom ply and one ply is a top ply, and wherein most of or all of the plies comprise fibres, wherein the stack comprises a plurality of plies having fibres substantially in the orthogonal direction 3 to the longitudinally direction L of the tool and the stack further comprises a plurality of plies having fibres substantially in the same direction 2 as the longitudinally direction L of the tool 21 and/or a plurality of plies having fibres substantially in the diagonal direction 4, 5, 6, 7, 8, 9 to the longitudinally direction L of the tool 21, so that when positioned on the tool 21 at least one of the ply/plies arranged in the orthogonal direction 3 to the longitudinal direction L of the tool 21 have fibres that are stiffer than the fibres in the other plies which have less stiff fibres;
   conforming the stack to the tool with a forming medium; and
   removing the article from the tool 61, 71. The article may be cured before or after removing the article from the tool.

The method further comprises the step of arranging a further stack of plies on the tool 21 after a conforming step and then conforming the further stack to the tool with a forming medium. This can be repeated several times. A stack of plies can be arranged on the tool, the stack is conformed to the tool with a forming medium, a further stack op plies is arranged on the tool 21 and the further stack is conformed to the tool with a forming medium. The further stack is arranged on top of the earlier stack of plies. This can be repeated until a desired numbers of plies are arranged on the tool 21. In addition, the plies can be applied or arranged on the tool 21 one at a time. This is considered to be encountered in the context of applying a stack of plies on a tool. It is not necessary to have a stack of plies before adding the stack on the tool. The stack can be arranged on the tool by adding a ply one at a time.

The stiffer fibres will avoid compression of those plies and thereby wrinkles are avoided during the forming of the article. Fibres in the orthogonal direction may be compressed in the longitudinal direction of the fibre during forming of the article. One reason for compression in the plies having fibres substantially in the orthogonal direction to the longitudinal direction of the article may be inter ply sliding in those plies during forming of the article. Intra ply sliding is sliding of the fibres in one ply, while inter ply sliding is sliding between the plies. When the fibres are sliding in the orthogonal direction, the fibres may be compressed in the fibre length and the fibres may then buckle. However, if the fibres are stiffer, the compression is avoided and the fibres will conform to the form of the tool. When producing the article, the stiffer fibres in the plies having fibres substantially in the orthogonal direction 810 avoid compression of the ply/plies. This avoids that the fibres are bended in the wrong direction and thus avoids wrinkling. The plies having stiffer fibres will cooperate with the plies having less stiff fibres in an advantageous way. The plies having less stiff fibres will not be deformed so easy when formed together with plies having stiffer fibres. The plies having stiffer fibres will also conform easier to the tool as disclosed above. A stiff fibre will not be compressed so easy, but will be conformed to the tool.

The fibre reinforced polymer plies have unidirectional fibres in the plies.

The method also comprises arranging at least one ply/plies with a cured ply thickness which is smaller than the cured ply thickness of the other ply/plies, so that the ply/plies with the smaller cured ply thickness have the fibres in the orthogonal direction 3 to the longitudinal direction L of the tool 1. When forming the article, compression in the fibre length direction of the plies having smaller cured ply thickness than the other plies is avoided and thereby is wrinkling of the plies avoided.

The method may also comprise to arrange ply/plies having fibres substantially in an orthogonal direction and having a smaller cured ply thickness and wherein the ply/plies also comprise fibres which are stiffer than the other plies which have less stiff fibres. However, it can also comprise to arrange one ply having fibres substantially in an orthogonal direction wherein the ply/plies may comprise stiffer fibres than the other plies, and arranging another ply having fibres substantially in an orthogonal direction that have a smaller cured ply thickness than other plies.

The method also relates to arrange ply/plies having a smaller cured ply thickness wherein they may have a cured ply thickness of <0.15 and the cured ply thickness of the other ply/plies may be >0.15. The method also relates to arrange ply/plies wherein the ply/plies having a smaller cured ply thickness have a cured ply thickness of ≦0.14 mm and the cured ply thickness of the other ply/plies ≧0.17 mm. With the difference of the cure thickness wrinkling is avoided since the compression is avoided of the ply/plies having a lower cured ply thickness.

The method also relates to arranging a bottom ply on the tool, wherein the bottom ply has fibres in the orthogonal direction and wherein the bottom ply fibres are stiffer than the fibres in the other plies which have less stiff fibres. The method may also comprise to arrange ply/plies having fibres substantially in the orthogonal direction and having stiffer fibres close to the tool. The effect of the stiffer fibres may be more advantageous close to the tool, since the compression of the fibres in the longitudinal direction of the fibres may be larger close to the tool.

The method also relates to arranging a bottom ply on the tool, wherein the bottom ply has a cured ply thickness which is smaller than the cured ply thickness of the other plies. The method may also comprise to arrange ply/plies having fibres substantially in an orthogonal direction and having a smaller cured ply thickness than the other plies close to the tool.

The method may also comprise arranging the ply/plies so that all ply/plies having fibres substantially in the orthogonal direction 3 comprise fibres that are stiffer than the other ply/plies. During forming of the article, the plies having stiffer fibres will avoid wrinkling at the same time as plies having less stiff fibres will avoid to be deformed. This combination will provide an article with very good properties, such as good mechanical properties.

Further, it may comprise arranging the ply/plies so that all ply/plies having fibres substantially in the orthogonal direction 3 has a cured ply thickness which is smaller than the cured ply thickness of the other ply/plies. This further avoids that the plies having smaller cured ply thickness will avoid wrinkling and will thus provide an article with very good mechanical properties.

Further, the method comprises arranging a ply 24 closest to the tool 21 and arranging a ply 25 furthest away from the tool 21 which have fibres substantially orthogonal 3 to the longitudinal direction L of the tool, and arranging at least one ply having the fibres substantially in the same direction 2 as the longitudinal direction L of the tool 21 between plies having fibres substantially orthogonal 3 to the longitudinal direction L of the tool 21 and arranging at least one ply having fibres substantially diagonal 4, 5 to the longitudinal direction L of the tool 1, 21, wherein such ply or plies are arranged next to each other or between plies having fibres substantially orthogonal 3 to the longitudinal direction L of the tool 1, 21.

The method further comprises arranging the stack 22, 42 so that when positioned on the tool 21, 41 the ply arranged closest 24, 44 to the tool 21, 41 has the fibres substantially orthogonal 3 to the longitudinal direction L of the tool 21, 41, the next four plies have the fibres substantially diagonal 4, 5 to the longitudinal direction L of the tool 21, 41, the next ply has the fibres substantially orthogonal 3 to the longitudinal direction L of the tool 21, 41, the next four plies have the fibres in substantially the same direction as the longitudinal direction L of the tool 21, 41, the next ply has the fibres substantially orthogonal 3 to the longitudinal direction L of the tool 21, 41, the four next plies have the fibres substantially diagonal 4, 5 to the longitudinal direction L of the tool 21, 41, the next ply has the fibres substantially orthogonal 3 to the longitudinal direction L of the tool 21, 41.

The tool may also comprise at least one curved part 38. At curved parts, such as corners, buckling is common to occur. The ply/plies having the fibres in the orthogonal direction to the longitudinal direction on the tool may bend in the wrong way and may be wrinkled quite easily during the forming of the article. When the fibres in the ply/plies having fibres substantially in the orthogonal direction to the longitudinal direction of the tool are stiffer, the buckling is avoided. The stiffer fibres avoids compression and thereby the buckling. This is especially useful at curved parts of tools. A curved part 38 is disclosed in the tool 31 and may be for example a corner.

Further, the present invention relates to a method, wherein the tool 31 has at least one depressed part 34 and at least one protruding part 35, 36 which protruding part is protruding in relation to the depressed part 34 of the tool 31. The tool 31 has at least one narrower part and at least one thicker part in the cross-section of the tool 31. The depressed areas 34 correspond to the narrower part of the tool 31. The protruding areas 35, 36 correspond to the thicker part of the tool 31.

In FIG. 3 there is one depressed part 34 on the tool 31. A tool can have several depressed parts. When forming a stack of plies on a tool comprising depressed and protruding parts, there is a transition area 39 between the depressed part 34 and the protruding part 35, 36. This area may form an inclined surface on the tool 31. In the side parts 37 there may be difficulties with wrinkles formed during the forming step. This problem is solved with the present invention by arranging the plies having substantially longitudinal direction L and plies having substantially diagonal direction 4, 5 between plies having orthogonal 3 fibres. The plies with longitudinal fibres L and diagonal fibres 4, 5 will slide between the plies having orthogonal fibres 3, and thereby wrinkles are avoided. The benefit is also obtained by that the plies arranged next to the tool and furthest away from the tool, thus next to the forming medium, are arranged orthogonal to the longitudinal direction L. At least one ply of the plies having the fibres in the longitudinal direction L of the tool and one of the plies having the fibres in the diagonal direction of the tool may comprise particles. This will improve the method of producing the article, since the fibres in the plies comprising particles will not move or slide as easily as without the particles. The particles will increase the friction between the fibres, which makes the fibres stay in their positions. This avoids thinning of the article, which together with the avoidance of wrinkles achieves a good composite article. It is also an advantage to use particles in a curved part of a tool, since this will avoid thinning of the article in the curved parts.

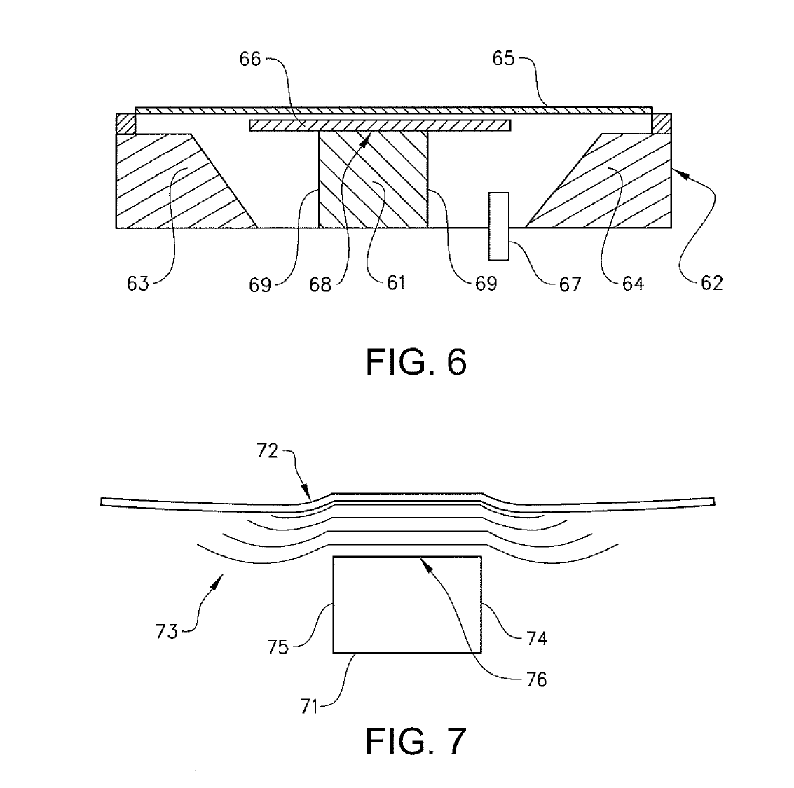

An apparatus for forming an article by conforming a stack according to the present invention is disclosed in FIG. 6 and in FIG. 7. A tool 61, 71 is disclosed with a stack 66, 73 and a forming medium 65, 72.

The stack may be arranged on a temporary support (not shown), where after the stack is transferred to the tool. The temporary support could be a plane and vertical support. The support could however have other forms. When referring to the directions of the fibres in the different plies, the direction always refer to the direction of the tool, to which the stack is transferred to when it refers to the method. Several prepregs or tapes may first be laid in the form of a stack. This is done by hand or by an Automatic Tape Laying Machine on a temporary support. This is followed by for example a Hot drape forming, HDF, process. The stack is transferred to the tool 61, 71 in a HDF apparatus 62 and then the stack may be heated up followed by conforming the stack 66, 73 with a forming medium 65, 72, which could be a vacuum bag made of an elastic bag material.

The article to be formed could for example be a beam. It can be seen in FIGS. 6 and 7 that the prepreg stack 66, 73 extends outside the top surface 68, 76 of the tool. When hot drape forming is performed, the outer parts of the stack will be forced down to the side edges 69, 74, 75 of the tool 61, 71 by a forming medium in the form of a vacuum bag and there form flanges in the article. The stack may also be forced down by mechanical means, such as rolls, when forming flanges in the article. Examples of flanges 802, 804 in an article 801 are shown in FIG. 8.

For easiness, the fibre direction of the plies will sometimes shortly be called orthogonal direction and the longitudinal direction, respectively. The direction is related to the tool or the article, depending on what is concerned in the circumstances.

For further simplifying the expressions, the plies having the fibres substantially orthogonal to the longitudinal direction of the tool or the article are sometimes called 90° plies, relating to the angle 90°. In the same way, the plies having the fibres substantially in the same direction as the longitudinal direction is called 0° plies, while the plies having the fibres substantially diagonal to the longitudinal direction of the tool or the article are called 45° and 135° plies or any other angle which is defined to be included in the diagonal direction, as defined to be 30° to 60° and 120° to 150°.

When forming a stack 22 of plies on a tool 21, the force from the forming medium will generate shearing forces onto the stack 22 of plies. There will also be shearing forces between the plies. When plies having a substantially orthogonal direction 3 to the longitudinal direction L of the tool is arranged closest to the tool 1, 21, and closest to the forming medium, the shearing forces between the plies and the tool and the forming medium, respectively, decrease. This means that the plies will slide on the tool and against the forming medium. This leads to a decrease in the risk of obtaining wrinkles in the article. Further, when plies having fibres substantially in the same direction 2 as the longitudinal direction L of the tool are situated between plies having fibres substantially in an orthogonal 3 direction to the longitudinal direction L of the tool 1, 21, the plies having fibres substantially in the same direction 2 as the longitudinal L direction will slide together with the plies having orthogonal 3 fibres. This also avoids wrinkles in the article. If wrinkles are formed in hot drape formed articles, the wrinkles are usually formed in the flanges 802, 804 of the articles. The flanges are the parts which are formed on the longitudinal sides of the tool. One longitudinal side 26 of the tool 21 can be seen in FIG. 2 and longitudinal sides 69, 74, 75 are shown in FIGS. 6 and 7. When the stacks are conformed over the corners 27 (FIG. 2) of the tool 21, the wrinkles may be formed on the longitudinal sides 26, close to the corners. This is also disclosed in FIG. 5. The wrinkles may be formed due to that the plies do not slide easily between each other, but are locked in positions forming wrinkles. When locked in the position, the fibres may be compressed in the fibre direction in the plies having fibres in the orthogonal direction of the longitudinal direction of the tool. The compression is avoided due to the stiffer fibres in the plies having fibres substantially in the orthogonal direction. The problems discussed with the wrinkles are the same for hot drape forming and mechanical forming.

The method according to the present invention also comprises
conforming the stack with a mechanical forming medium.

The forming medium may be a mechanical forming medium, such as a roll or press forming.

The method according to the present invention can also comprise
conforming the stack by hydroforming or vacuum forming with an elastic membrane.

Further, the method comprises
enclosing the stack within a forming medium 65, 72,
evacuating the forming medium 65, 72 for allowing the forming medium to stretch and conform the stack 66, 73 to the tool 61, 71.

According to the present invention, the forming medium 65, 72 used under the forming step can be an elastic vacuum bag.

The method thus relates to a method that comprises
conforming the stack with a mechanical forming medium, or enclosing the stack within a forming medium (65, 72),
evacuating the forming medium (65, 72) for allowing the forming medium to stretch and conform the stack (66, 73) to the tool (61, 71).

As disclosed above, the forming medium may be a hydroforming or vacuum forming medium or a mechanical forming medium.

The evacuating step may be performed in all temperature ranges. After the forming step, an elevated temperature may be used in order to obtain a faster curing of the article. The curing may also be performed at ambient temperature.

The prepregs are in the form of resin impregnated fibres. The resin could be thermosetting resins such as epoxy, polyester, cyanate ester, vinyl ester, BMI (bismaleimide), or thermoplastics such as PPS (poly(p-phenylene sulfide), PEI (polyethylene imine), PEEK (polyetheretherketone). The fibres are for example carbon fibres, glass fibres, organic fibres and ceramic fibres.

With a stack sequence according to the present invention, a both intra and inter ply sliding effect can be obtained, which is advantageous when used for making articles which will result without wrinkles. The plies having stiffer and optionally smaller cured ply thickness improve the inter ply sliding during forming in that the compression of the stiffer fibres and the plies having smaller cured ply thickness are avoided which reduces the risk of wrinkling.

The present invention also relates to a composite article produced according to the method disclosed above. An article according to the present invention has been able to produce without wrinkles.

The stack may also be laid directly on the tool. This can be made by advanced fibre placement (AFP). The method would not include the hot drape forming for conforming the stack to the tool, since the plies will conform to the tool when laid on to the tool. By this method wrinkles are also avoided in the articles formed by the method which utilizes direct laying the stack onto the tool.

The description and definition of the plies applies for both the article and the method according to the present invention.

1-13. (canceled)

14. A composite article (801), wherein the article has a longitudinal direction (L) and a transversal direction (T), the article (801) comprises a stack of plies, wherein the plies are resin plies, wherein one ply is a bottom ply and one ply is a top ply, most of or all of the plies comprise fibres, the fibre reinforced plies have unidirectional fibres in the plies, and the stack comprises a plurality of plies having fibres substantially in the orthogonal direction (810) to the longitudinal direction (L) of the article (801) and the stack further comprises a plurality of plies having fibres substantially in the same direction (811) as the longitudinally direction (L) of the article (801) and/or a plurality of plies having fibres substantially in the diagonal direction (812, 813, 815, 816, 817, 818) of the longitudinal direction (L) of the article (801), wherein at least one of the ply/plies having fibres substantially in the orthogonal direction (810) to the longitudinal direction (L) of the article (801) comprise fibres that are stiffer than the fibres in the other plies which have less stiff fibres and at least one of the ply/plies having fibres substantially in the orthogonal direction (810) to the longitudinal direction (L) of the article (801) has a cured ply thickness which is smaller than the cured ply thickness of the other ply/plies.

15. A composite article according to claim 14, wherein the ply/plies having a smaller cured ply thickness have a cured ply thickness of ≦0.14 mm and the cured ply thickness of the other ply/plies ≧0.17 mm.

16. A composite article according to claim 14, wherein all the plies having fibres substantially in the orthogonal direction (810) comprise fibres that are stiffer than the fibres in the other plies.

17. A composite article according to claim 14, wherein all the plies having fibres substantially in the orthogonal direction (810) has a cured ply thickness which is smaller than the cured ply thickness of the other ply/plies.

18. A composite article according to claim 14, wherein the bottom ply (24) and the top ply (25) have fibres in a substantially orthogonal direction (810) to the longitudinal (L) direction of the article (801) and at least one ply has the fibres substantially in the same direction (811) as the longitudinal direction (L) of the article (801) arranged between plies having fibres substantially orthogonal (810) to the longitudinal direction (L) of the article (801) and it further comprises at least one ply having fibres substantially diagonal (812, 813, 815, 816, 817, 818) to the longitudinal direction (L) of the article (801), wherein such ply or plies are arranged next to each other or between plies having fibres substantially orthogonal (810) to the longitudinal direction (L) of the article (801).

19. A composite article according to claim 14, wherein the article comprises at least one curved part (814).

20. A method of forming an article on a tool, the tool having one longitudinal direction L and one transversal direction T, wherein the method comprises the steps of:
(A) arranging a stack (22) of plies (23), wherein:
the plies are resin plies;
one ply is a bottom ply (24) and one ply is a top ply (25);
substantially all of the plies comprise fibres; and
the stack comprises a plurality of plies having fibres substantially in the orthogonal direction (3) to the longitudinally direction (L) of the tool and the stack further comprises a plurality of plies having fibres substantially in the same direction (2) as the longitudinally direction (L) of the tool (21) and/or a plurality of plies having fibres substantially in the diagonal direction (4, 5, 6, 7, 8, 9) to the longitudinally direction (L) of the tool (21), so that when positioned on the tool (21) at least one of the ply/plies having fibres substantially in the orthogonal direction (3) to the longitudinal direction (L) of the tool (21) have fibres that are stiffer than the fibres in the other plies which have less stiff fibres and arranging at least one ply/plies with a cured ply thickness which is smaller than the cured ply thickness of the other ply/plies, so that the ply/plies with the smaller cured ply thickness have the fibres substantially in the orthogonal direction (3) to the longitudinal direction (L) of the tool (1);
(B) conforming the stack to the tool with a forming medium; and
(C) removing the article from the tool (61, 71) after curing.

21. A method according to claim 20, further comprising the step of arranging a further stack of plies on the tool (21) after a conforming step and then conforming the further stack to the tool with a forming medium.

22. A method according to claim 20, further comprising arranging ply/plies wherein the ply/plies a having smaller cured ply thickness have a cured ply thickness of ≦0.14 mm and the cured ply thickness of the other ply/plies is ≧0.17 mm.

23. A method according to claim 20, further comprising arranging the ply/plies so that all ply/plies having fibres substantially in the orthogonal direction (3) comprise fibres that are stiffer than the other ply/plies.

24. A method according to claim 20, further comprising arranging the ply/plies so that all ply/plies having fibres substantially in the orthogonal direction (3) has a cured ply thickness which is smaller than the cured ply thickness of the other ply/plies.

25. A method according to claim 20, wherein the ply (24) arranged closest to the tool (21) and the ply (25) arranged furthest away from the tool (21) have fibres substantially orthogonal (3) to the longitudinal direction (L) of the tool, and arranging at least one ply having the fibres substantially in the same direction (2) as the longitudinal direction (L) of the tool (21) between plies having fibres substantially orthogonal (3) to the longitudinal direction (L) of the tool (21) and it further comprises arranging at least one ply having fibres substantially diagonal (4, 5) to the longitudinal direction (L) of the tool (1, 21), wherein such ply or plies are arranged next to each other or between plies having fibres substantially orthogonal (3) to the longitudinal direction (L) of the tool (1, 21).

26. A method according to claim 20, wherein the tool comprises at least one curved part (38).
